(19) United States
(12) Patent Application Publication
(10) Pub. No.: US 2008/0138149 A1
(43) Pub. Date: Jun. 12, 2008

(54) Adjustable Armrest And A Locking Mechanism Therefore

(76) Inventors: Tormod Selbekk, Trondheim (NO); Kristine Holbo, Trondheim (NO)

Correspondence Address: LADAS & PARRY LLP, 26 WEST 61ST STREET, NEW YORK, NY, 10023, US

(21) Appl. No.: 11/597,034

(22) PCT Filed: Jun. 10, 2005
(86) PCT No.: PCT/NO05/00199

§ 371 Date: Jul. 25, 2007

(30) Foreign Application Priority Data
Jun. 11, 2004 (NO) 20042444

(51) Int. Cl. F16C 11/06; F16B 7/00

(52) U.S. Cl. 403/24; 403/81

(57) ABSTRACT

The present invention concerns an adjustable arm rest with a support face (1), an operating lever (3), a joint apparatus adapted for being secured to an arm rest carrier (7) and a locking apparatus. The joint apparatus allows pivoting of the arm rest about three axis, and the at least one operating lever (3) locks or re-leases the joint apparatus and thereby the placement of the apparatus in relation to the arm rest carrier (7) in the three axes. Furthermore, a lockable joint apparatus is described.

The present invention concerns an adjustable arm rest and a locking mechanism.

The arm rest can be adjusted freely about three axes, in addition to being shifted lengthwise by operation of one single lever or handle. The arm rest is particularly adapted for surgeons and other professions that need support, particularly during precision surgery that extends over longer periods, and that normally imposes considerable strain on the surgeon. Furthermore a joint mechanism allowing movement about three axes, in addition to a translatory motion is described.

A chair with an adjustable arm rest, in particular for surgeons, is shown in U.S. Pat. No. 5,029,941, describing arm rests that can be pivoted about two axes by tightening of a lever that additionally is secured to a chair by various joints.

During manual labour with high intensity, and that requires high precision, it can be desirable to have arm support that is easily adjustable. In connection with surgery, it is also necessary that a surgeon remains completely sterile. To achieve this, it is common to rap up elements that not can be sterilized, for instance the operation chair. Accordingly it is a goal with the present invention to be able to provide adjustable arm rests that easily can be adjusted in all angles by for instance a surgeon, and that at the same time the arm rest easily can be wrapped up in sterile material without this restricting operating handles in that the operating handle can be actuated through a sterile wrapping.

This and other aspects are solved with an adjustable arm rest and a locking mechanism according to the present invention.

Accordingly the present invention describes an adjustable arm rest with at least one lever, a joint apparatus adapted to be secured in an arm rest carrier and in the arm rest, and a locking device. The joint apparatus allows pivoting of the arm rest about three axis, and the at least one lever selectively locks or releases the joint apparatus and thereby the positioning of the arm rest in relation to the arm rest carrier in the three axis. At least one lever can be placed in front on the arm rest such that it easily can be reached by someone sitting on a chair where the arm rest is placed. When the lever is pulled in a direction for instance away from the arm rest, the joint apparatus is released, and the arm rest can be adjusted as needed for by user. The three axis the arm rest can be pivot corresponds to pivoting that can be performed by a ball joint or a gimbal joint where a shaft also can be pivoted or rotated, and accordingly allows angular displacement of the arm rest forwards, backwards, sideways and in rotation.

The joint apparatus can also allow translatoric movement between the arm rest and the arm rest carrier. In other words, the arm rest can in one embodiment be shifted back and forth on an arm rest carrier, and accordingly in relation to for instance a chair where the arm rest carrier is placed.

In one embodiment it may be only one lever and this lever locks or releases the arm rest in relation to the arm rest carrier in the motion about the three axes and in translatoric motion. However, the invention may also include other embodiments where for instance one lever can be provided for translatoric motion, and one for pivoting about the three axes. In yet another embodiment it can be one lever for each axis.

Furthermore, the invention concerns a lockable joint apparatus including a housing for securing the joint apparatus. Two guide rails or tracks are connected to the housing. At least one lever can adjust a clamping force applied to a compressible ball joint carrier. The ball joint carrier is adapted for slidable contact with the two tracks or guide rails connected to the housing. At least two clamping faces on the ball joint carrier for contact with a joint ball is placed in the ball joint carrier such that the clamping of the ball joint carrier towards the joint ball by the lever mutually locks the elements of the joint.

The housing can provide a base for securing or placing the components of the joint apparatus. Two parallel locking rails with variable distance therein between, and longitudinal holding parts can be placed in the housing along with a lever for adjusting the mutual distance between the locking rails. A compressible ball joint carrier with a ball socket can be made with at least two parallel faces placed between the locking rails and held between these by the longitudinal holding parts. A joint ball is placed in the ball socket such that clamping of the locking rails simultaneously presses the ball joint carrier towards the joint ball and the locking rails, and mutually locks the elements of the joint.

The faces between the ball joint carrier, the joint ball and/or the locking rails may have a rough surface for improved friction. The ball join carrier can be compressible in that it is divided into two parts or includes a compressible area such that the carrier can be compressed about the joint ball when the locking rails are pressed towards the carrier. The longitudinal holding parts can for instance be formed in that the locking rails are cranked at an angle, such that it is created a guide for the carrier. The holding parts on the locking rails will normally point towards each other to secure that the carrier not can be removed from the rails even when the rails are held apart and the carrier is free to perform a translatoric motion along the rails.

The joint apparatus may furthermore include elastic elements or spring elements pressing or biasing the locking rails towards each other with a force to a normally compressed position, and a release mechanism connected to the lever can release the force when it is actuated. Alternatively the locking rails can be operated or activated by instance actuators, such as pneumatic elements, hydraulic elements or electric motors.

The joint apparatus may furthermore include compressing elements or clamping elements that changes the internal distance between the parallel locking rails by longitudinal displacement of at least one of the locking rails in relation to the housing, and the spring elements can be biased towards a position where the locking rails presses towards the ball joint carrier and locks the joint element. The clamping elements can be pivoted elements that pivot the locking rails apart when the locking rails are moved in relation to the housing for the locking mechanism when the clamping elements are secured between the housing and the locking rails. Alternatively the joint elements can be substituted by balls in keyways, by cam elements, or other elements well known within the subject area for imposing a wedge force by linear displacement of an element.

The joint apparatus may furthermore include elastic elements that directly or indirectly press the ball joint carrier with a force to a normally compressed position. The elastic elements may be metal springs, elastomeric or other suitable elements and may for instance be formed with a leaf shape, a spiral shape, a belleville spring shape etc. A release mechanism connected to the lever releases the force by actuating the lever.

The joint apparatus may include compressing elements that change the internal distance between the parallel locking rails by longitudinal displacement of at least one of the locking rails in relation to the housing. The spring elements may hold the at least one of the locking rails against longitudinal displacement.

The elastic elements may be placed between the two elements forming the ball joint carrier.

An eccentric or cam shaped rod can be supported in the housing, and can be rotated about a longitudinal axis by actuation of the lever to press the parts of the ball joint carrier apart for releasing the joint ball. The rod may have a circular cross section, have and oval cross section, a shape as a cam shaft of a four stroke combustion engine, or any other shape that when rotated about a shaft will be able to press an element adjacent the rod. The rod is preferably revolvably supported and extends parallel to the housing, the guide rails or the tracks connected to the housing.

The lever may activate the elements that ensure that the parts of the ball joint carrier are separated from each other for releasing the joint ball mechanically or manually in that the lever directly affect the element that ensures that the ball is released in relation to the ball joint carrier.

Alternatively the handle may actuate the elements that ensure that the parts of the ball joint carrier are separated for releasing the joint ball by a powered actuator. In this case, the handle will typically affect an electrical switch, potentiometer or similar elements that typically will affect an electrically driven actuator for releasing the joint.

### SHORT DESCRIPTION OF THE ENCLOSED FIGURES

FIG. 1 shows an embodiment of an arm rest according to the invention;

FIG. 2 shows the arm rest of FIG. 1, seen from below, where also a locking mechanism is shown;

FIG. 3 furthermore shows the arm rest from FIGS. 1 and 2, where details of the locking mechanism are shown;

FIGS. 4a and 4b shows the arm rest from the remaining figures where the details of the locking mechanism are further shown and where the locking mechanism is shown in a locked and a released position;

FIG. 5 is a principal drawing of a ball joint in cross section according to an embodiment of the invention;

FIG. 6 shows a detail of an alternative embodiment of a clamping element in cross section;

FIG. 7 is a principal drawing of a ball joint in cross section according to another embodiment of the invention;

FIG. 8 shows the embodiment of FIG. 7 from a different angle;

FIG. 9 is a principal drawing of a ball joint in cross section according to yet another embodiment of the invention;

FIG. 10 is a principal drawing as shown on FIG. 9, but where eccentric release bars are in a second position; and

FIG. 11 is a principal drawing as shown on FIG. 9, but where the eccentric release bars are in a third position.

### DETAILED DESCRIPTION OF THE SHOWN EMBODIMENTS

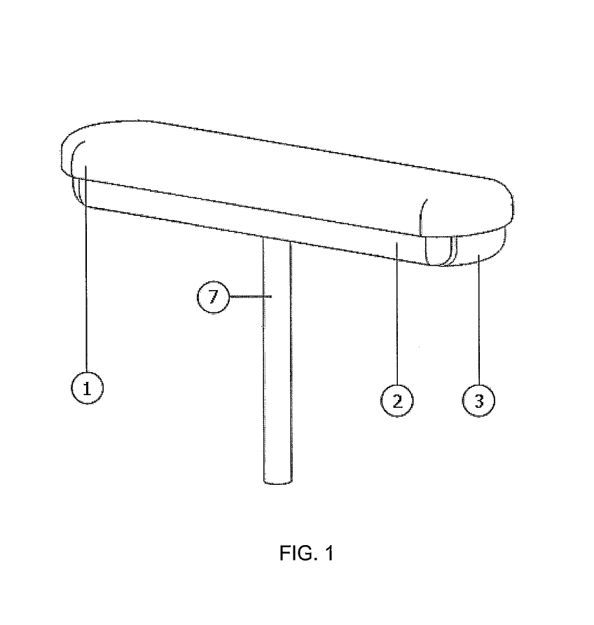

From FIG. 1 it is shown an adjustable arm rest according to the invention. The arm rest includes a rest or support face 1 preferably for an arm. An arm rest carrier 7 with a joint ball is secured to the arm rest. An arm rest housing 2 houses a locking mechanism for the arm rest, and an operating lever 3 at the foremost end of the arm rest.

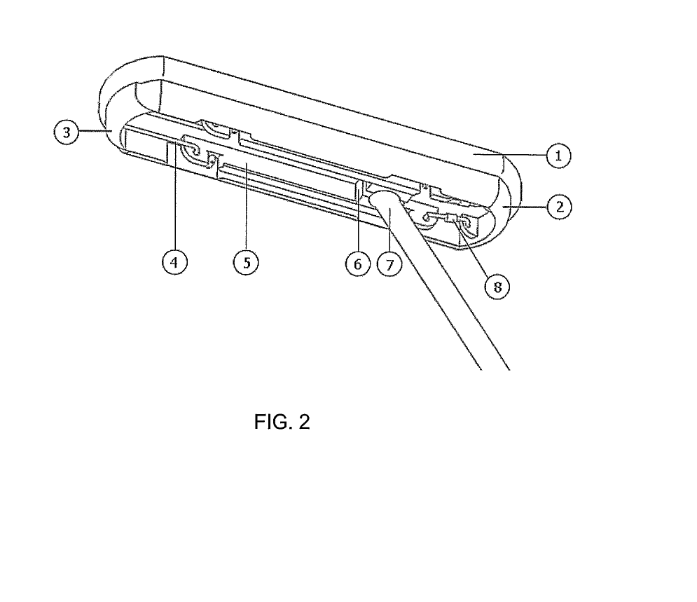

From FIG. 2 the arm rest as shown on FIG. 1 is shown, but where details with the locking mechanism are clearly shown. FIG. 2 shows the arm rest 7 in another position than the one shown on FIG. 1. From the figure it is shown how the lever 3 may pull a locking rail 5 by a release pushrod 4. An elastic element 8 holds the locking rail 5 in a first position with a ball joint carrier 6 pressed between the locking rail 5 and a joint ball on the arm rest carrier 7. By imposing a force on the lever 3, the locking rail 5 will be displaced in relation to the housing 2 against the force of the elastic elements 8 for releasing the clamping and for adjusting the arm rest in relation to the arm rest carrier 7.

The locking rails or clamp with the elastic element 8 ensures that the joint element or the ball joint carrier 6 is compressed, and this in turn compresses and locks the joint ball/ball joint carrier 7. When the lever or handle 3 is pulled out, the locking rails 5 are parallely displaced in relation to the housing 2 of the arm rest, such that the ball joint carrier or joint element 6 is released. The ball joint carrier 6 can now be moved along the locking rails 5 and is at the same time released to rotate about the joint ball of the arm rest carrier. When the lever 3 is released, the locking rails 5 are parallely displaced back to the locking position.

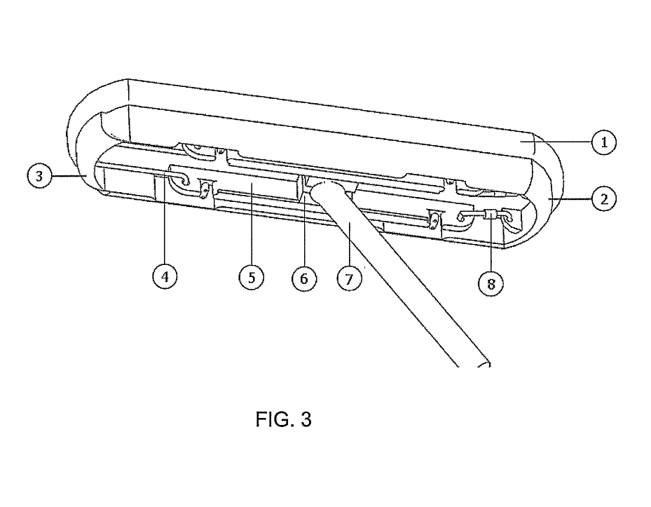

FIG. 3 shows the arm rest shown on FIG. 2, but where the arm rest carrier 7 is adjusted in a different position. By comparing FIG. 3 with the remaining figures, FIG. 3 clearly shows the adjustment possibilities of the arm rest.

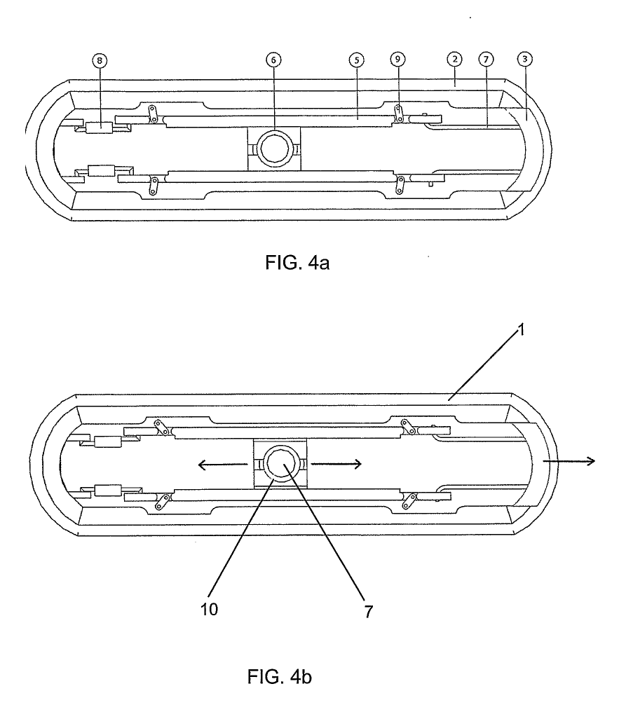

From FIGS. 4a and 4b it is shown the embodiment of the invention as shown on FIGS. 1, 2 and 4, but where the locking mechanism for the arm rest carrier 7 is shown in further detail. Of FIG. 4a the mechanism is shown in a locked position, and on FIG. 4b the mechanism is shown in a released position. From the figures it is clearly shown a housing 2 for the locking mechanism, and that the foremost part of the housing for the locking mechanism includes a lever 3 for releasing the locking mechanism, such that the arm rest carrier 7 with a joint ball can be released and such that the arm rest can be displaced back and forth on the arm rest carrier 7, and such that the arm rest can be rotated and placed at an angle in an infinite number of positions.

The joint allows pivoting about three axis and linear displacement of the arm rest carrier 7.

In the locked condition, the locking rail 5 presses against the ball joint carrier 6, such that friction between the locking rails 5 and ball joint carrier 6 prevents the ball joint carrier 6 and thereby the arm rest carrier 7 from sliding back and forth along the locking rails 5. Friction between the ball joint carrier 6 and the joint ball 10 on the arm rest carrier 7 prevents motion therein between when the locking rail 5 presses towards the ball joint carrier 6 and accordingly the joint ball 10 on the arm rest carrier 7. When the lever 3 is pulled outwards in relation to the housing 2 for the locking mechanism, the clamping elements 9 between the housing 2 for the locking mechanism and locking rails 5 are released, such that the force between the locking rails 5, the ball joint carrier 6, and the joint ball 10 on the arm rest carrier 7 is reduced and such that these accordingly can mutually be moved. The clamping elements 9 are shown as joint elements rotating the locking rails 5 apart when the locking rails 5 are displaced in relation to the housing 2 for the locking mechanism when the clamping elements 9 are placed between these. Four clamping elements 9 are shown, one at each end of each locking rail. However, one of the locking rails could be fixed to the housing 2 and the other locking rail could ensure release and locking of the ball joint carrier 6.

Ball joint carrier 6 is in two parts or includes an elastic area, that ensures that the forces the clamping elements 9 imposes on the ball joint carrier 6 by the locking rails 5 then are transferred to the joint ball 10 of the arm rest carrier 7. The relationship between the clamping force of the clamping elements 9, the pulling force of the elastic element 8, the friction between the joint elements, the joint ball 10 and the locking rail 5, and the area of the interfaces will have to be adjusted to provide sufficient locking of the arm rest in relation to the arm rest carrier 7 when the lever 3 not is operated.

With the invention it is achieved that the arm rest can be tilted sideways, tilted up/down, the leading or trailing edge can be moved up and down, and the arm rest can at the same time shifted or displaced back and forth with one grip. To perform a change of position of the support face, the handle 3 is pulled out with the fingers simultaneously as an arm rests on the support face. The locking rail 5 is then moved forwards and releases the ball joint carrier 6. The arm rest can now be positioned in a desired working position.

The object of the invention is to achieve a multi functional working face based on one grip. The principal is based on parallel displacement, and this is then intended as a locking mechanism.

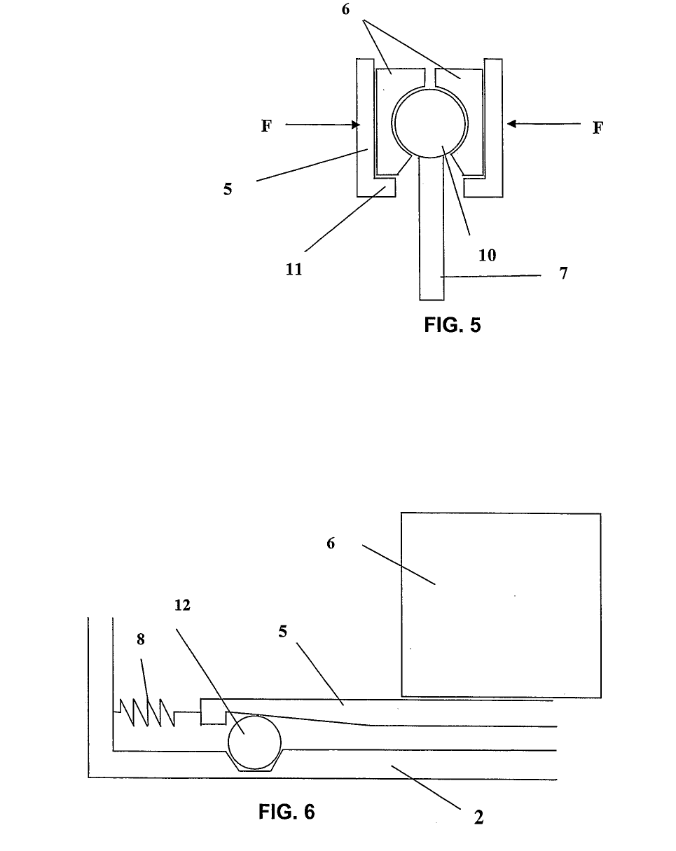

FIG. 5 is a principal drawing of a joint element or a ball joint carrier 6 as shown on the previous figures, designed with a two part gliding block with a ball socket and at least two parallel faces between the locking rails 5. The joint ball 10 is placed in the ball sockets.

By applying a force F frictional forces are applied between the rail 5, the ball joint carrier 6 and the joint ball 10.

From the figure it is clearly shown how the application of a force F will lock both the ball joint carrier 6 in relation to the rails 5 and the joint ball 10 secured to the arm rest carrier 7.

Furthermore, it is clearly shown how the holing parts 11 and the rails 5 holds the ball joint carrier 6 to the rails 5.

FIG. 6 shows an alternative embodiment of a clamping element where it is shown that a ball 20 in a key way can press a rail 5 away from the arm rest housing 2 when the eccentric element 8 pulls the rail 5 in a direction to the left. Accordingly this mechanism can be used to press and secure a ball joint carrier 6 and a joint ball (not shown). A lever (shown as 3 on FIG. 1-4) can pull the rail to the right by a release pushrod such that the force against the ball joint carrier 6 cease, and the joint is released.

The ball joint carrier 6, the ball joint 10 and the released rail 5, must be made of materials that ensures sufficient friction between the elements. Furthermore, the intersection between these elements can be interlocking, had an uneven structure, or in any other way be provided with surfaces that ensures good locking between the elements when the clamping elements 9 clamps the locking rails 5 towards the ball joint carrier 6 and the joint ball 10 on the arm rest 7. The faces between the rails 5, the ball joint carrier 6 and the joint ball 10 can be made of materials that will ensure sufficient friction during locking, and may in alternative embodiment include rough or serrated surfaces to further ensure locking of the elements in relation to each other when the force F is applied.

The clamping—or pivot elements 9 can for instance be substituted by cam—elements or other elements well known within the subject area for applying a wedge force resulting from a linear displacement of an element.

FIG. 7 shows an alternative embodiment of a lockable joint apparatus according to the invention. In this embodiment the ball joint carrier 6 is made of two substantially plate shaped bodies with holes that are pressed towards one another and that presses against the joint ball 10. In this embodiment the elastic element 8 is placed between the substantially plate shaped bodies and presses these bodies against the joint ball 10, such that the ball 10 is locked to the plate shaped bodies that constitutes the ball joint carrier 6 and thereby locks the joint at a given angle. The elastic elements 8 are shown as springs each placed in a cup 16, with a screw placed in the middle of a coil spring. The springs are tightened in that a nut 17 is screwed on to the screw, and thereby the plates are pressed towards each other and thereby towards the ball 10. The spring force can be adjusted by tightening/slacking the nut 17. The joint can be adjusted by an eccentric rod 15 on both the left and right side, with the effect that one of the plates are displaced perpendicular on the ball (as apposed to inclined). On FIG. 7 the solution also includes roles 18 that can be brought in contact with the rod 15, such that one of the plates on the ball joint carrier 6 can roll along the eccentric rod 15 for translational motion even if the rod 15 is in an position where the ball 10 is released from the ball joint carrier. This means that when a lever or actuator is operated by a user, eccentric rod 15 is rotated, the joint can perform both a translation motion and twisting or pivoting at the same time. In this embodiment the rod 15 may include pins 19 for interference with suitable recesses or bodies (not shown), such that translational motion along for instance a securing pin 20 for interference with a groove, will be prevented by a certain rotation of the rod 15.

FIG. 8 shows the embodiment shown on FIG. 7 seen from above. On this figure it is clearly shown how the eccentric release bars 15, the rollers 18, the ball 10, the ball joint carrier 6, the elastic elements 8, and pins 19 on the eccentric release rods are placed in relation to each other. On this figure it is also shown a plastic cup or plastic liner 21 between the ball key and the locking face on the ball joint carrier 6. A hard ball 10 (for instance ceramic) makes it possible to use a hard plastic lining, which gives less wear than a soft plastic lining 21. The plastic lining 21 may have a certain area on the ball, and may be adapted to the curvature of the ball 10. To increase the locking force, it can be necessary with a certain texture on the plastic lining 21 and on the ball 10. Alternatively the hole in the locking plate of the ball joint carrier can be cut straight (not coned). The result will be that the locking will be performed with a high pressure on a small surface. A locking force distributed on a larger face that surrounds the ball may however give a better locking of the ball joint. Alternatively the plastic lining 21 may include lamellas that surround the ball. Texture on the lining and the ball will provide increased friction and thereby better locking of the ball joint. Metal to metal, for instance steel, on ball 10 and the locking plates can be used, but this solution may ha tendency to get jammed and may result in considerable wear.

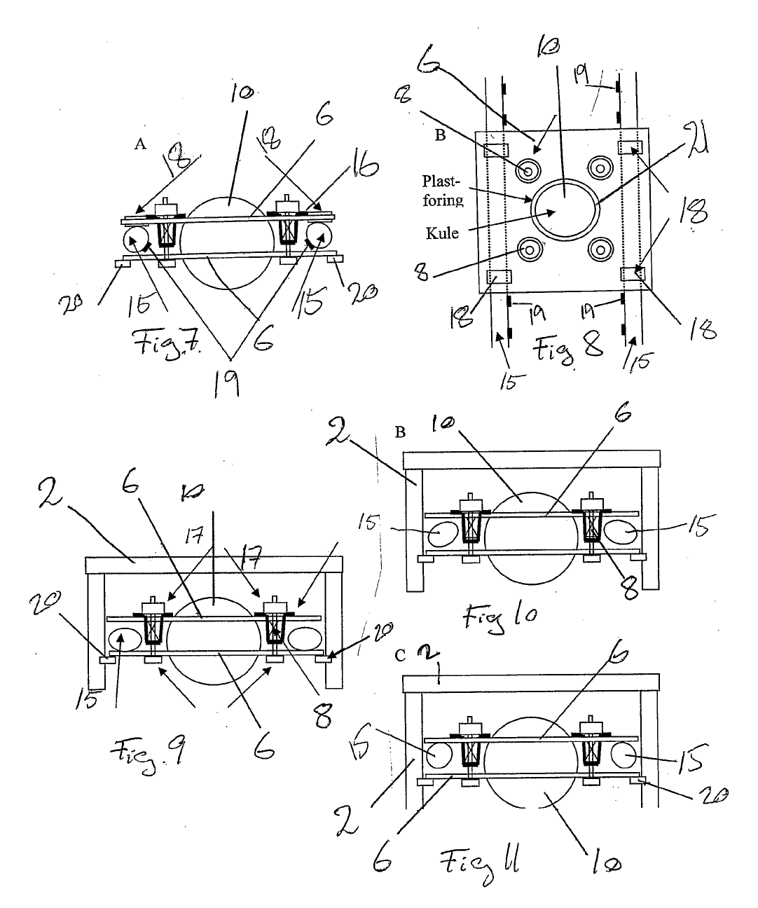

In FIG. 9 the rods 15 are jammed or wedged towards one of the plates, and the translational motion is thereby locked. When a lever is somewhat lifted, the plates are pressed apart, and the arm rest can be adjusted back/force (FIG. 10). If the handle is lifted further the rods presses the upper plate upwards (against the spring load) and the arm rests can be rotated to the intended angle (FIG. 11). When the lever is released the springs will lock the ball joint. The weight of the lever will press the rods towards the lower plate, and thereby lock the back/forth motion.

With the solution shown on FIG. 9, 10, 11, translation and rotation can not be adjusted at the same time. Rotation and translation must be adjusted with different positions of the rod 15, and accordingly of the handle or lever for adjusting the joint. From the FIGS. 9, 10 and 11 it is shown how the translational motion is achieved with the gliding pin 20 that can slide in a groove for instance in an arm rest or a housing. Locking for translational motion can be achieved by including pins 19 on the release rods 15 as shown on FIG. 7,8 that can interfere with grooves (not shown) on the lower plate.

The levers may preferably be placed at a lower edge of the arm rest, and have a practical motion upwards to adjust the arm rest. The arm rest is locked by releasing the lever.

It is preferably only one adjustment lever or a handle instead of separate handles for allowing adjustment of rotation and translation. Vertical motion of the regulating lever, is considered to be the most use friendly solution, and safest when covered with a sterile cover. The adjustment handle can be pulled upwards to release the locking, and be released to relock the arm rest.

1. A lockable joint apparatus comprising a housing (2);
a compressible ball joint carrier (6) with press faces for interference with a joint ball (10) placed in the ball joint carrier (6);
at least one operating lever (3) for adjusting a clamping force applied to the compressible ball joint carrier (6) and for clamping the ball joint carrier (6) to the joint ball (10) characterized in that:
the ball joint carrier is adapted for sliding contact with longitudinal holding parts, tracks, grooves with pins or guide rails (11, 20) connected to the housing for allowing translational motion between the ball joint carrier (6) and the housing (2); and
at least one rail or rod (5, 15), actuated by the at least one lever (3), extending along the housing (2), for selectively locking or releasing the ball (10) in relation to the ball joint carrier (6) and the ball joint carrier in relation to the housing (2), in three axes and the translational direction.

2. The lockable joint apparatus according to claim 1, characterized in that the longitudinal holding parts (11) includes two parallel rails (5) with a variable distance therein between;
the at least one operating lever (3) is provided to regulate the internal distance between the two parallel rails (5);
the press faces of the compressible ball joint carrier (6) are ball socked shaped and the ball joint carrier (6) furthermore includes at least two parallel faces placed between the rails (5) and is held between these by the longitudinal holding parts (11); and
the joint ball (10) is placed in the ball socked such that compression of the rails (5) simultaneously presses the ball joint carrier (6) towards the joint ball (10) and locks the elements of the joint therein between.

3. The lockable joint apparatus according to claim 2, characterized in that the faces between the ball joint carrier (6), the joint ball (10) and/or the rails (5) are rough for improved friction.

4. The lockable joint apparatus according to claim 1, characterized in that it includes elastic elements (8) that directly or indirectly presses the ball joint carrier (6) towards the ball (10) with a force to a normally compressed position, and
the rails or rods (5, 15), actuated by the lever (3), releases the force when operated.

5. The lockable joint apparatus according to claim 4, characterized in that it includes two rails (5), that these rails (5) are parallel, and in that it includes pressing elements (9) that changes the internal distance between the parallel rails (5) by longitudinal displacement of at least one of the rails (5) in relation to the housing (2), and
that the elastic elements (8) elastically holds at least one of the rails (5) against longitudinal displacement.

6. The lockable joint apparatus according to claim 4, characterized in that the ball joint carrier (6) is formed of two elements and that the elastic elements (8) are placed between the two elements that forms the ball joint carrier (6).

7. The lockable joint apparatus according to claim 1, characterized in that the rod (15) is formed with a shape that when rotated about a longitudinal axis is able to press an element adjacent the rod, is supported in the housing, and can be rotated about the longitudinal axis by operation of the handle to press the parts of the ball joint carrier (6) away from each other to release the joint ball (10) from the ball joint carrier (6).

8. The lockable joint apparatus according to claim 1, characterized in that the lever (3) mechanically actuates the rods or rails (5, 15) to release the joint ball (10) from the ball joint carrier (6).

9. The lockable joint apparatus according to claim 1, characterized in that the handle actuates a powered actuator, actuating the rails or rods (5, 15) to release the joint ball (10) from the ball joint carrier (6).

10. The lockable joint apparatus according to claim 1, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

11. The lockable joint apparatus according to claim 2, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

12. The lockable joint apparatus according to claim 3, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

13. The lockable joint apparatus according to claim 4, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

14. The lockable joint apparatus according to claim 5, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

15. The lockable joint apparatus according to claim 6, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

16. The lockable joint apparatus according to claim 7, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

17. The lockable joint apparatus according to claim 8, wherein the housing (2) forms a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.

18. The lockable joint apparatus according to claim 9, wherein the housing (2) form a part of an adjustable arm rest including a support face (1), the joint ball (10) is fixed to an arm rest carrier (7), and the operating lever (3) is placed on said arm rest and selectively locks or releases the arm rest in relation to the arm rest carrier (7) about three axes of rotation and in a longitudinal direction.
